(19) United States
(12) Patent Application Publication
(10) Pub. No.: US 2005/0182230 A1
(43) Pub. Date: Aug. 18, 2005

(54) Chlorendic anhydride/maleic anhydride compositions and method for preparing same

(76) Inventors: Wesley Wayne McConnell, Grayslake, IL (US); Sujatha Kondubhotla, Libertyville, IL (US); Makarand Joshi, Grayslake, IL (US); Eric Zimmermann, Chongqing (CN); John Wittenauer, Soddy Daisy, TN (US); Neal Netzel, South Elgin, IL (US); Bruce Stanhope, Yardley, PA (US); Vladimir Zhukhovytskyy, Glenview, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 10/777,345

(22) Filed: Feb. 12, 2004

(51) Int. Cl. C08G 63/00

(52) U.S. Cl. 528/271

(57) ABSTRACT

Mixtures of chlorendic anhydride and maleic anhydride that are completely free of liquid hydrocarbons and liquid halohydrocarbons without the need for any purification are novel and are prepared by reacting hexachlorocyclopentadiene with a stoichiometric excess of maleic anhydride in the absence of solvents. The process is useful for preparing other Diels-Alder reaction products from maleic anhydride.

### BACKGROUND OF THE INVENTION

1. Field of the Invention

This invention relates to mixtures of chlorendic anhydride and maleic anhydride. More particularly, this invention relates to those mixtures that are entirely free of organic solvents. This invention also provides a process for preparing chlorendic anhydride/maleic anhydride mixtures employing no materials other than the reactants, specifically hexachlorocyclopentadiene and maleic anhydride. This process does not require the liquid hydrocarbon associated with prior art methods for preparing these mixtures, thereby avoiding the associated problems of recovery and either disposal or recycling of the recovered hydrocarbon.

The anhydride mixtures of this invention can be combined with one or more dihydric alcohols to prepare flame retardant polyesters.

The present method is useful for preparing other Diels-Alder type reaction products of a conjugated cyclic diene with a cyclic alkene. One or both of the reactants can contain substituents that are not reactive during a Diels-Alder reaction.

2. Related Prior Art

U.S. Pat. No. 3,868,397, issued to Jay A, Cull and Walter M. Zimberg, describes a process for preparing chlorendic anhydride, the proper nomenclature for which is 1,4,5,6,7,7-hexachlorobicyclo-(2,2,1)-5-heptene-2,3-dicarboxylic anhydride. In accordance with this process, hexachlorocyclopentadiene (HCCPD) is reacted with maleic anhydride (MA) in the presence of up to 10 weight percent, based on total reactants, of an organic solvent boiling within the range of from 110 to about 180° C. The HCCPD is at least 98 percent pure and the molar ratio of MA to HCCPD is from 1.01 to 1.1. The two reactants are heated in the presence of the organic solvent for between 3 and 30 hours at a temperature of from 110 to 180° C. The resultant solution is then preferably poured out onto a flat surface such as a tray and exposed to subatmospheric pressure to evaporate any remaining solvent. The dried material is reduced to a particulate form by grinding or other known method and recovered as a finely divided solid.

Aromatic hydrocarbons and halogenated hydrocarbons are preferred solvents.

In accordance with the teaching of this patent, the organic solvent is required “to maintain the condensation reaction mass fluid at the reaction temperature and is substantially removed during the vacuum heating step”.

The present invention is based on the discovery that by using a molar ratio of MA to HCCPD of at least 1.1:1 the reaction mixture can be maintained as a liquid throughout the reaction without undergoing decomposition. The prior art avoids this decomposition by requiring a solvent to liquefy the crude reaction mixture. The present method eliminates the use and the associated requirement of disposal or recycling of a solvent together with the safety and environmental issues associated with the use of these solvents. Even relatively minute amounts of these solvents can impart undesirable color and flammability to the final reaction product.

An additional and unexpected advantage of the present method is that the reaction product, a solvent-free mixture of chlorendic and unreacted maleic anhydrides, is a brittle, dry solid at 25° C. that can be reduced to dust-free flakes or other particulate forms using known mechanical techniques. This form of product cannot be achieved using the solvent required as part of the prior art techniques for preparing chlorendic anhydride from the reactants of the present method.

Mixtures of chlorendic and maleic anhydrides are useful for preparing flame-retardant polyesters by reacting the mixtures with one or more dihydric alcohols such as ethylene and propylene glycols. The reaction products of the present invention can be used for this purpose without additional processing such as removal of the liquid hydrocarbons and/or halocarbons used to prepare prior art anhydride mixtures. This advantage has not heretofore been available using prior art techniques for preparing chlorendic anhydride.

### SUMMARY OF THE INVENTION

The compositions of the present invention are mixtures consisting essentially of chlorendic anhydride and maleic anhydride in the absence of liquid hydrocarbons and halohydrocarbons. The molar ratio of maleic anhydride to chlorendic anhydride is at least 1.1:1.

The present compositions are prepared using a novel process comprising, heating hexachlorocyclopentadiene in a reactor with agitation and the absence of liquid hydrocarbons and liquid halohydrocarbons;
gradually adding a quantity of molten maleic anhydride equivalent to at least 1.1 times the number of moles of hexachlorocyclopentadiene initially present in said reactor while heating and agitating the resultant reaction mixture sufficiently to maintain it as a molten material;
following completion of the maleic anhydride addition, maintaining said molten material for a period of time sufficient for a substantially complete conversion of said hexachlorocyclopentadiene to chlorendic anhydride, which is present as a molten reaction product together with unreacted maleic anhydride; and
cooling said molten reaction product to form a solid mixture of chlorendic and maleic anhydrides.

Alternatively, the hexachlorocyclopentadiene can be gradually added to molten maleic anhydride.

The solid reaction product can be reduced to any desired particle size without the formation of powdery material typically resulting from solvent removal from product prepared using liquid hydrocarbons as a reaction medium.

This invention also encompasses polyester precursors comprising at least one dihydric alcohol and a mixture of chlorendic and maleic anhydrides of the present invention. The molar ratio of the alcohol to total anhydride is typically about 1:1.

### DETAILED DESCRIPTION OF THE INVENTION

In accordance with the present method, maleic anhydride (MA) is reacted with hexachlorocyclopentadiene (HCCPD) in a molar ratio of at least 1.1:1 and at a temperature at which all reactants and reaction products are liquids or solubilized solids. Depending upon the ratio of HCCPD to MA and the purity of the reactants, this temperature is at least 120° C., preferably between 150 and 175° C.

The molar ratio of maleic anhydride to HCCPD is preferably from 1.15:1 to 3:1. This preference is based on the melting point of the final reaction mixture, the desired HCCPD conversion (typically at least 99 percent) and the desired reaction rate.

The reaction is conducted using only the two reactants in the absence of any reaction medium such as the liquid hydrocarbons employed in prior art methods for preparing chlorendic anhydride. When one attempts use of the 1:1 molar ratio of MA to HCCPD disclosed in the prior art, the present inventors found that the reaction will not go to completion due to solidification of the reaction mixture.

One of the advantages of using at least a 10 percent stoichiometric excess of MA is that throughout the reaction the reaction mixture can be maintained in a molten state by selection of a suitable reaction temperature that will not result in decomposition of reactants or products. A second advantage is that this excess ensures maximum conversion of the HCCPD to chlorendic anhydride. Prior art methods require use of a solvent for the product, which is a solid at temperatures conventionally used for this reaction.

The reaction between a conjugated diene and a monounsaturated organic compound, referred as a Diels-Alder reaction, is typically exothermic. For this reason, one of the reactants is preferably added gradually to the other one.

Maleic anhydride melts between 60 and 70° C. To facilitate transfer of this compound into the reactor, it is preferably heated to above its melting point and gradually added to the HCCPD as a molten material.

Prior to addition of the MA the HCCPD is heated to a temperature of at least 135° C., preferably between 145 and 180° C.

Because the reaction is exothermic and MA is susceptible to thermally induced discoloration, the rate of MA addition should be controlled to avoid a substantial excess unreacted anhydride in the reaction mixture over that required to maintain a liquid reaction medium at the desired reaction temperature.

Alternatively, HCCPD, which is a liquid at 25° C., can be gradually added to the desired quantity of molten MA in the reactor.

To ensure that substantially all of the desired amount of HCCPD reacts, heating of the reaction mixture is continued for at least four hours following completion of the anhydride addition. It will be understood by those skilled in the art that the preferred heating period will depend upon a number of variables, including but not limited to size of the reaction vessel, the quantity of excess anhydride, the reaction temperature and the volume of the reactants.

Any unreacted HCCPD remaining following completion of the reaction can be removed by vaporization under reduced pressure or other means known to those skilled in the art for removing relatively low-boiling impurities.

To minimize formation of undesirable by-products it is preferred that the concentration of impurities in both reactants does exceed about 2 percent by weight.

In accordance with the present method, the reaction of the HCCPD and MA is conducted under conditions that will minimize formation of by-products, particularly those causing discoloration of the reaction product.

Surprisingly it has been found that color of products prepared under an atmosphere containing from 2 to 21 volume percent of oxygen is superior to the color of products prepared under an atmosphere consisting essentially entirely of an inert gas such as nitrogen. While the reason for this is not completely understood, it is believed that any colored impurities formed during the reaction are oxidized to colorless ones.

The reaction product, a mixture of chlorendic and maleic anhydrides, melts from about 90 to about 180° C., depending upon the quantity of unreacted maleic anhydride. This reaction product is most easily isolated by pouring it from the reaction vessel while still in the molten state. Upon cooling the melt forms a brittle solid that is easily fragmented to the desired particle size without grinding and the associated formation of powdery material. The health and environmental issues associated with finely divided powders are thereby avoided.

The color of the product varies from light to medium yellow, depending upon concentration of colored impurities such as compounds containing conjugated double bonds.

Because the chlorendic anhydride/maleic anhydride mixtures of this invention are prepared in the absence of the liquid hydrocarbons necessitated by prior art methods for preparing chlorendic anhydride, there are none of the flammability, recovery and disposal problems typically associated with the use of these hydrocarbons in laboratory and industrial scale processes.

The present mixtures of maleic and chlorendic anhydrides are particularly useful for preparing precursors for flame retardant polyesters by combining the mixtures with at least one dihydric alcohol. Suitable dihydric alcohols contain from 2 to 10 or more carbon atoms and include but are not limited to ethylene glycol, propylene glycol, 1,2 propane diol, 1,4-butanediol, neopentyl glycol and 1,6-hexane diol. Ethylene glycol, propylene glycol and neopentyl glycol are preferred dihydric alcohols. The molar ratio of dihydric alcohol to total moles of anhydride is typically 1:1.

In addition to the reaction of MA with HCCPD described in the preceding specification, the method of this invention can be used to prepare Diels-Alder reaction products from any cyclic conjugated diene and monoolefinically unsaturated compounds.

The present method is particularly useful when at least one of the reactants is a solid at 25° C., with the proviso that at the reaction temperature the reactants form a liquid mixture and do not decompose.

The following example describes a preferred embodiment of the present method for preparing chlorendic anhydride/maleic anhydride mixtures. Unless otherwise specified all parts and percentages are by weight.

### EXAMPLE 1

Eight hundred (800) parts of HCCPD were placed in a glass reactor equipped with heating means, a thermometer, a water-cooled condenser, a mechanically driven stirrer, an addition funnel equipped with means for heating the contents, a gas inlet tube extending to the bottom of the reactor and connected to a compressed air source, and a gas inlet providing a nitrogen atmosphere above the reactants.

With the gases flowing through both inlets, the HCCPD was heated to 160° C., at which time 373.9 parts of molten maleic anhydride were gradually added from the heated addition funnel. The temperature of the maleic anhydride in the funnel was 90° C. The maleic anhydride was added to the reactor at a rate of 6.2 grams per minute while the contents of the reactor were stirred and heated at 160° C.

Following completion of the MA addition, stirring and heating of the reaction mixture at 160° C. was continued for about 4 hours together with the flow of gases through both gas inlet tubes. The molten contents of the reactor were then poured out onto a supported sheet of aluminum foil and allowed to cool. The solidified material fragmented into dry flakes when the foil was lifted off the supporting surface and manipulated. The flakes were from off white to light yellow in color. The reaction product melted at 125° C.

The low residual concentration of HCCPD in the reaction product was confirmed by high performance liquid chromatography.

### EXAMPLE 2

This example describes 1) an alternative method for preparing the chlorendic anhydride/maleic anhydride mixtures of the present invention and 2) addition of a glycol to form a polyester precursor.

Step 1—Production of Crude Chlorendic Anhydride

One hundred and fifty (150) parts of HCCPD were placed in a glass reactor equipped with heating means, thermometer, water-cooled condenser, mechanically activated stirrer, a pressure-equalizing addition funnel equipped with a heating means, a gas inlet tube extending to the bottom of the reactor and connected to a compressed air source, and a gas inlet providing a nitrogen atmosphere above the reactants. Using a compressed air flow rate of 9.52 ml./minute and a nitrogen flow rate of 90.48 ml./minute the HCCPD was heated to 174° C., at which time 53.92 parts of molten MA were added from the heated addition funnel over a 90 minute period with stirring.

Heating of the reaction mixture was continued for an additional 30 to 45 minutes following completion of the addition. The reaction mixture was then allowed to cool to 150° C. Following from 30-45 minutes at this temperature the reaction mixture began to thicken. At this time 100.3 parts of molten MA were added from the addition funnel at a rate sufficient to avoid an exothermic reaction. This addition required from 30 to 60 minutes. Following completion of the addition the temperature of the reaction mixture was stirred and maintained at a temperature of 150° C.

Reaction of the Chlorendic Anhydride/Maleic Anhydride Mixture with a Glycol to Form a Polyester Precursor

The reaction mixture described in the preceding paragraph was cooled to 90° C., at which time 136.17 parts of a 90 weight percent aqueous solution of neopentyl glycol that had been pre-heated in the addition funnel to a temperature of 90° C. were added over a 60 minute period. The rate of addition and cooling of the reactor were adjusted to maintain the temperature of the reaction mixture below 110° C. Following completion of the glycol addition the reaction mixture was stirred for one hour to yield the final polyester.

1. A solid mixture consisting essentially of chlorendic anhydride and maleic anhydride in the absence of liquid hydrocarbons and halohydrocarbons, wherein the molar ratio of maleic anhydride to chlorendic anhydride is at least 1.1:1.

2. A mixture according to claim 1 wherein the molar ratio of maleic anhydride to chlorendic anhydride is from 1.15:1 to 3:1.

3. A mixture according to claim 1 wherein the melting point of said mixture is below the decomposition temperature of said mixture.

4. A mixture according to claim 3 wherein the melting point of said mixture is from 90 to 180° C.

5. A method for preparing a solid mixture consisting essentially of chlorendic and maleic anhydrides, wherein said method comprises the steps of:
heating a quantity of hexachlorocyclopentadiene to at least 120° C. in a reactor in the absence of liquid hydrocarbons or liquid halohydrocarbons;
gradually adding to said reactor a quantity of molten maleic anhydride equivalent to at least 1.1 times the number of moles of hexachlorocyclopentadiene initially present in said reactor while heating and agitating the resultant mixture sufficiently to maintain it as a molten material;
following completion of the maleic anhydride addition, maintaining said molten material for a period of time sufficient for a substantially complete conversion of said hexachlorocyclopentadiene to chlorendic anhydride, which is present as a molten reaction product together with unreacted maleic anhydride; and
cooling said molten reaction product to form a solid mixture of chlorendic and maleic anhydrides.

6. A method according to claim 5 wherein the molar ratio of maleic anhydride to chlorendic anhydride is from 1.15:1 to 3:1 and said hexachlorocyclopentadiene is heated to between 150 and 175° C.

7. A method according to claim 5 wherein the temperature of said molten material is maintained below the decomposition temperature of said hexachlorocyclopentadiene and maleic anhydride.

8. A method according to claim 5 wherein the melting point of said material mixture is from 90 to 180° C.

9. A method according to claim 5 wherein the said reaction mixture is in contact with a gas mixture containing from 2 to 21 volume percent oxygen while in a molten state.

10. A method according to claim 5 wherein the concentrations of impurities in said hexachlorocyclopentadiene and initial maleic anhydride do not exceed 2 weight percent.

11. A method according to claim 5 wherein said solid mixture is combined with a dihydric alcohol to form a polyester precursor.

12. A method for preparing a solid mixture consisting essentially of chlorendic and maleic anhydrides, wherein said method comprises the steps of:
heating a quantity of maleic anhydride to at least 145° C. in a reactor in the absence of liquid hydrocarbons or liquid halohydrocarbons;
gradually adding to said reactor a quantity of hexachlorocyclopentadiene equivalent to at least 1.1 times the number of moles of the maleic anhydride initially present in said reactor while heating and agitating the resultant mixture sufficiently to maintain it as a molten material;
following completion of the hexachlorocyclopentadiene addition, maintaining said molten material for a period of time sufficient for a substantially complete conversion of said hexachlorocyclopentadiene to chlorendic anhydride, which is present as a molten reaction product together with unreacted maleic anhydride; and
cooling said molten reaction product to form a solid mixture of chlorendic and maleic anhydrides.

13. A method according to claim 12 wherein the molar ratio of maleic anhydride to chlorendic anhydride is from 1.15:1 to 3:1 and said maleic anhydride is heated to between 150 and 175° C.

14. A method according to claim 12 wherein the temperature of said molten material is maintained below the decomposition temperature of said hexachlorocyclopentadiene and maleic anhydride.

15. A method according to claim 12 wherein the melting point of said material mixture is from 90 to 180° C.

16. A method according to claim 12 wherein the said reaction mixture is in contact with a gas mixture containing from 2 to 21 volume percent oxygen while in a molten state.

17. A method according to claim 12 wherein the concentrations of impurities in said hexachlorocyclopentadiene and initial maleic anhydride do not exceed 2 weight percent.

18. A method according to claim 12 wherein said solid mixture is combined with a dihydric alcohol to form a polyester precursor.

19. A polyester precursor comprising the reaction product of at least one dihydric alcohol and a mixture consisting essentially of chlorendic anhydride and maleic anhydride in the absence of liquid hydrocarbons and halohydrocarbons, wherein the molar ratio of maleic anhydride to chlorendic anhydride is at least 1.1:1.

20. A precursor according to claim 19 wherein the molar ratio of maleic anhydride to chlorendic anhydride is from 1.15:1 to 3:1.

21. A precursor according to claim 19 wherein said dihydric alcohol contains from 2 to 10 carbon atoms.

22. A precursor according to claim 19 wherein the molar ratio of all dihydric alcohols to total anhydrides present in said mixture is from 0.5:1 to 1.5:1.
